(19) United States
(12) Patent Application Publication
(10) Pub. No.: US 2004/0056084 A1
(43) Pub. Date: Mar. 25, 2004

(54) Document handling apparatus

(76) Inventor: John Alan Skinner, Hampshire (GB)

Correspondence Address: Oliff & Berridge, PO Box 19928, Alexandria, VA, 22320, US

(21) Appl. No.: 10/416,578

(22) PCT Filed: Oct. 30, 2001
(86) PCT No.: PCT/GB01/04794

(30) Foreign Application Priority Data
Nov. 20, 2000 (GB) 0028263.2

(51) Int. Cl. G06F 17/60

(52) U.S. Cl. 235/379

(57) ABSTRACT

Document handling apparatus comprises a document transport system defining a transport path (1, 2) along which documents are conveyed. A sensor system (5) monitors documents transported along the transport path, the sensor system including an ultra-violet (UV) light source (9), a first detector (11) located on the opposite side of the transport path to the UV light source for detecting UV light transmitted across the transport path, and a second detector (12) located on the same side of the transport path as the UV light source for detecting radiation emitted by and/or reflected from a document transported along the transport path in response to incident UV light from the UV light source

The invention relates to document handling apparatus for example for handling documents of value such as banknotes.

It is important in such document handling apparatus to be able to obtain information about certain properties of the document such as their size and position and, in the case of certain documents of value, authenticity information such as their response to ultraviolet (UV) irradiation.

Traditionally, banknote handling apparatus such as counters, sorters and acceptors use separate detectors for measuring the size and position of banknotes and for measuring the UV properties. The size/position detectors are typically transmissive sensors, requiring the note to interrupt a beam of light, usually infra-red or visible. This type of detector may be used accurately to measure the size of the note in the direction of travel (either short edge or long edge leading) or to provide an indication of the presence of a document.

The UV detectors are reflective sensors which measure the amount of light scattered from the surface of the note, either at the original UV wavelength or at a different wavelength caused by fluorescence or phosphorescence. Optical filters mounted over the receiver are used to select the wavelength of the received light. An example is described in GB-A-2047402.

There is a need to reduce the complexity and cost of these known systems.

In accordance with the present invention, document handling apparatus comprises a document transport system defining a transport path along which documents are conveyed; and a sensor system for monitoring documents transported along the transport path, the sensor system including an ultra-violet (UV) light source, a first detector located on the opposite side of the transport path to the UV light source for detecting UV light transmitted across the transport path, and a second detector located on the same side of the transport path as the UV light source for detecting radiation emitted by and/or reflected from a document transported along the transport path in response to incident UV light from the UV light source.

With this apparatus, the same UV light source is used for generating UV radiation which passes across the transport path to the first detector and thus could be used for determining size (for example for determining denomination in the case of banknotes) or position of documents and for generating radiation which is either reflected by the document or causes further radiation to be emitted by the document or both, the radiation from the document being detected by the second detector. The use of a single light source significantly reduces the complexity of the apparatus and thus reduces cost.

A further advantage of the apparatus is that the first detector can be used to calibrate the light source when no document is present.

Preferably, the apparatus further comprises a second sensor system for monitoring documents transported along the transport path, the second sensor system including a light source, and a detector located on the opposite side of the transport path to the light source for detecting light transmitted across the transport path laterally spaced from light transmitted across the transport path by the first sensor system. This enables the angle of skew to be determined by reference to the relative times at which the document arrives at each sensor system. In principle, the second sensor system could be implemented using a light source which generates visible or invisible radiation but in practice the system may be too close to the first sensor system to allow UV light to be used and too close to other sensors which use infra-red light. Preferably, therefore, the light source in the second sensor system generates light with a wavelength in the visible region, for example green light.

Although the light source(s) could be provided by conventional bulbs or lamps, preferably they comprise light emitting diodes since these are cheaper, smaller and easier to control as well as being more stable.

The output signals from the first sensor system can be used for a variety of purposes. For example, the apparatus may further comprise a monitoring system coupled to the first detector of the first sensor system for determining information related to the length of a document in the transport direction. Alternatively, the output from the first detector could be used simply to determine the presence or time of arrival of a document.

Preferably, the monitoring system is also coupled to the detector of the second sensor system, when provided, in order to determine the orientation of a document being transported. As before, the second sensor system can be used to monitor presence of the document.

In addition, a monitoring system is preferably coupled to the second detector of the first sensor system for determining information relating to the authenticity of a document. It is known, for example, in the case of banknotes that the paper on which banknotes are printed is “UV dull” as compared with papers on which counterfeit banknotes are often printed which are UV bright. The reflectance intensity or fluorescence can therefore be used as an authenticity parameter.

Typically, a single monitoring system will be provided connected to all detectors.

An example of banknote handling apparatus according to the present invention will now be described with reference to the accompanying drawings, in which:

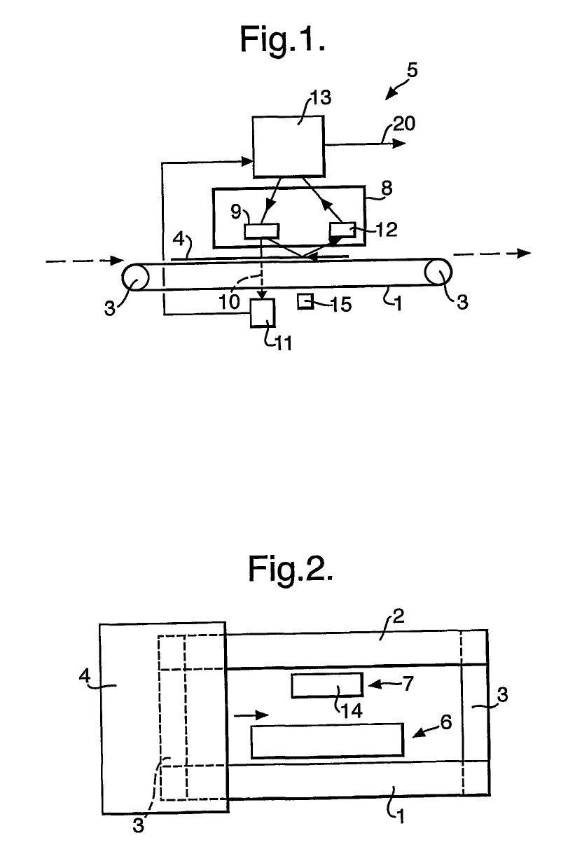

FIG. 1 is a schematic side view of part of the apparatus; and,

FIG. 2 is a schematic plan of part of the apparatus shown in FIG. 1.

The apparatus shown in FIG. 1 forms a small part of otherwise conventional banknote handling apparatus such as a banknote counter, sorter, dispenser, recirculator, validator or acceptor. Banknotes are supplied to the part shown in FIG. 1 from an input location (not shown), pass through the apparatus shown in FIG. 1, and then pass on to a diverter (not shown) which feeds the banknotes to one of a number of output locations. Alternatively, if a single output location only is provided, then the banknote will be fed to that output location but with an indication, if necessary, of an error such as a non-authentic note. That indication might be the stopping of the apparatus or simply a visual indication.

As can be seen in the drawings, the apparatus comprises a pair of laterally spaced feed belts 1,2 entrained around rollers 3. A banknote 4 is supplied to the belts 1,2 which are rotated (by means not shown) so as to move the banknotes, long edge leading, through a detection station 5.

The detection station 5 comprises a pair of sensor systems 6,7 substantially equally spaced on either side of a centre line defined between the belts 1,2.

The sensor system 6 comprises a support block 8 positioned above the note path and including a UV LED 9 for generating a UV beam 10 (with a wavelength typically in the range 200-380 nm) which passes out through a window (not shown) in the support block 8, across the path of the banknotes and is detected by a photodiode 11. The photodiode 11 is provided with a filter to remove all but UV light.

The support block 8 includes a second photodiode 12 for receiving UV light reflected from the banknote 4 or emitted by way of flourescence or phosphorescence from the banknote 4 in response to UV irradiation. The photodiode 12 is therefore provided with an optical filter designed to pass any blue light (typically 400-700 nm although it could be set for other colours depending on the document property being measured). Filters can be selected so that the photodiode 12 can be set either to detect reflected light or fluorescence or both.

The LED 9 and photodiodes 11,12 are each connected to a microprocessor 13. Output signals from the photodiodes 11,12 are converted into digital form and received by the microprocessor 13 which monitors the intensity of the received light. The information received from the photodiode 12 can be used to determine authenticity by comparing the received intensity with one or more thresholds and in particular to determine whether the received intensity indicates UV dull or UV bright paper. Depending upon the outcome of the authenticity determination a suitable signal will be output on a line 20 to control a diverter (not shown), provide an error message or the like.

The output from the photodiode 11 is used to sense the arrival of the banknote 4 and also to detect its trailing edge so that its length can be determined. This could allow denomination also to be detected.

Sometimes, banknotes can be fed at a skew angle and to compensate for this, the second sensor system 7 is provided. This system includes a green LED 14 positioned above the note transport path and a photodiode 15 provided with a green filter to remove noise from other stray light and to detect light emitted by the LED 14. The photodiode 15 is coupled to the microprocessor 13 (by means not shown) and is used also to determine the time of arrival of the leading edge of a banknote 4. If the times of arrival determined by the two sensor systems 6,7 are not the same this indicates that the banknote is skew fed and this can be compensated for.

Instead of the second system 7, a second UV system with either a photodiode for measuring UV light transmitted across the transport path (similar to the photodiode 11) or reflected from the document (similar to the photodiode 12) could be used or the second reflective photodiode could be set to detect a different wavelength range from the photodiode 12 of the first sensor system.

Although a belt system example of the document transport is provided, the detection system could equally be used in roller type document transport systems or any other type of known document transport arrangements.

1. Document handling apparatus comprising a document transport system defining a transport path along which documents are conveyed; and a sensor system for monitoring documents transported along the transport path, the sensor system including an ultra-violet (UV) light source, a first detector located on the opposite side of the transport path to the UV light source for detecting UV light transmitted across the transport path, and a second detector located on the same side of the transport path as the UW light source for detecting radiation emitted by and/or reflected from a document transported along the transport path in response to incident UV light from the UV light source.

2. Apparatus according to claim 1, further comprising a second sensor system for monitoring documents transported along the transport path, the second sensor system including a light source, and a detector located on the opposite side of the transport path to the light source for detecting light transmitted across the transport path laterally spaced from light transmitted across the transport path by the first sensor system.

3. Apparatus according to claim 2, wherein the light source of the second sensor system generates light with a wavelength in the visible region.

4. Apparatus according to claim 3, wherein the light source of the second sensor system generates green light.

5. Apparatus according to any of the preceding claims, wherein the light sources comprise light emitting diodes.

6. Apparatus according to any of the preceding claims, further comprising a monitoring system coupled to the first detector of the first sensor system for determining information related to the length of a document in the transport direction.

7. Apparatus according to claim 6, when dependent on claim 2, wherein the monitoring system is also coupled to the detector of the second sensor system in order to determine the orientation of a document being transported.

8. Apparatus according to any of the preceding claims, further comprising a monitoring system coupled to the second detector of the first sensor system for determining information relating to the authenticity and/or denomination of a document.

9. Banknote handling apparatus including an input receptacle for receiving a stack of banknotes; document handling apparatus according to any of the preceding claims; and one or more output receptacles, the transport system conveying banknotes from the input receptacle to the or one of the output receptacles.

10. Apparatus according to claim 9, when dependent on any of claims 6 to 8, wherein the monitoring system is adapted to control the transport system in accordance with information determined from the detector(s).

11. Apparatus according to claim 10, when dependent on claim 7, wherein the apparatus comprises more than one output receptacle, the monitoring system causing the transport system to convey banknotes to selected output receptacles in accordance with their determined authenticity and/or denomination.
